(19) United States
(12) Patent Application Publication
(10) Pub. No.: US 2025/0261178 A1
(43) Pub. Date: Aug. 14, 2025

(54) TECHNIQUES FOR MULTIPLE BANDWIDTH UTILIZATION IN A WIDEBAND CARRIER DURING INITIAL ACCESS

(71) Applicant: Lenovo (United States) Inc., Morrisville, NC (US)

(72) Inventors: Karthikeyan Ganesan, Nauheim (DE); Ravi Kuchibhotla, Chicago, IL (US); Ali Ramadan Ali, Kraiburg am Inn (DE)

(21) Appl. No.: 19/171,069

(22) Filed: Apr. 4, 2025

(51) Int. Cl. H04W 72/0457; H04W 56/00; H04W 68/02; H04W 74/0833

(52) U.S. Cl. CPC H04W 72/0457; H04W 56/0015; H04W 68/02; H04W 74/0833

(57) ABSTRACT

Various aspects of the present disclosure relate to techniques for multiple bandwidth utilization in a wideband carrier during initial access. An apparatus is configured to partition a wideband carrier into a plurality of bandwidth parts (BWPs), wherein each of the plurality of BWPs is mapped to a device type, a traffic type, or a combination thereof; transmit a first set of information on a first BWP of the plurality of BWPs, wherein the first BWP and the first set of information is common for each of the device types or traffic types; transmit second sets of information on second BWPs of the plurality of BWPs, wherein each of the second BWPs and the second sets of information are configured for a device type or a traffic type; and perform initial access procedure with one or more devices based on the first set of information and the second sets of information.

### TECHNICAL FIELD

The present disclosure relates to wireless communications, and more specifically to techniques for multiple bandwidth utilization in a wideband carrier during initial access.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

An NE for wireless communication is described. The NE may be configured to, capable of, or operable to partition a wideband carrier into a plurality of bandwidth parts (BWPs), wherein each of the plurality of BWPs is mapped to a device type, a traffic type, or a combination thereof; transmit a first set of information on a first BWP of the plurality of BWPs, wherein the first BWP and the first set of information is common for each of the device types or traffic types; transmit second sets of information on second BWPs of the plurality of BWPs, wherein each of the second BWPs and the second sets of information are configured for a device type or a traffic type; and perform initial access procedure with one or more devices based on the first set of information and the second sets of information.

A processor for wireless communication is described. The processor may be configured to, capable of, or operable to partition a wideband carrier into a plurality of BWPs, wherein each of the plurality of BWPs is mapped to a device type, a traffic type, or a combination thereof; transmit a first set of information on a first BWP of the plurality of BWPs, wherein the first BWP and the first set of information is common for each of the device types or traffic types; transmit second sets of information on second BWPs of the plurality of BWPs, wherein each of the second BWPs and the second sets of information are configured for a device type or a traffic type; and perform initial access procedure with one or more devices based on the first set of information and the second sets of information.

A method for wireless communication performed by an NE is described. The method may be configured to, capable of, or operable to partition a wideband carrier into a plurality of BWPs, wherein each of the plurality of BWPs is mapped to a device type, a traffic type, or a combination thereof; transmit a first set of information on a first BWP of the plurality of BWPs, wherein the first BWP and the first set of information is common for each of the device types or traffic types; transmit second sets of information on second BWPs of the plurality of BWPs, wherein each of the second BWPs and the second sets of information are configured for a device type or a traffic type; and perform initial access procedure with one or more devices based on the first set of information and the second sets of information.

A UE for wireless communication is described. The UE may be configured to, capable of, or operable to receive a first set of information on a first BWP of a plurality of BWPs, wherein the first BWP and the first set of information is common for different device types or traffic types; receive a second set of information on a second BWP of the plurality of BWPs, wherein the first set of information includes an indication of the second BWP based on the device type or traffic type associated with the UE; and perform initial access procedure based on the first set of information and the second set of information.

A processor for wireless communication is described. The processor may be configured to, capable of, or operable to receive a first set of information on a first BWP of a plurality of BWPs, wherein the first BWP and the first set of information is common for different device types or traffic types; receive a second set of information on a second BWP of the plurality of BWPs, wherein the first set of information includes an indication of the second BWP based on the device type or traffic type associated with the UE; and perform initial access procedure based on the first set of information and the second set of information.

A method for wireless communication performed by a UE is described. The method may be configured to, capable of, or operable to receive a first set of information on a first BWP of a plurality of BWPs, wherein the first BWP and the first set of information is common for different device types or traffic types; receive a second set of information on a second BWP of the plurality of BWPs, wherein the first set of information includes an indication of the second BWP based on the device type or traffic type associated with the UE; and perform initial access procedure based on the first set of information and the second set of information.

### BRIEF DESCRIPTION OF THE DRAWINGS

FIG. 1 illustrates an example of a wireless communications system, in accordance with aspects of the present disclosure.

FIG. 2A illustrates an example of wideband operation, in accordance with aspects of the present disclosure.

FIG. 2B illustrates an example of wideband operation, in accordance with aspects of the present disclosure.

FIG. 2C illustrates an example of wideband operation, in accordance with aspects of the present disclosure.

FIG. 3 illustrates an example of a UE, in accordance with aspects of the present disclosure.

FIG. 4 illustrates an example of a processor, in accordance with aspects of the present disclosure.

FIG. 5 illustrates an example of an NE, in accordance with aspects of the present disclosure.

FIG. 6 illustrates a flowchart of a method performed by an NE, in accordance with aspects of the present disclosure.

FIG. 7 illustrates a flowchart of a method performed by a UE, in accordance with aspects of the present disclosure.

### DETAILED DESCRIPTION

Generally, the present disclosure describes systems, methods, and apparatuses for techniques for multiple bandwidth utilization in a wideband carrier during initial access. In certain examples, the methods may be performed using computer-executable code embedded on a computer-readable medium. In certain examples, an apparatus or system may include a computer-readable medium containing computer-readable code which, when executed by a processor, causes the apparatus or system to perform at least a portion of the below described solutions.

In wireless networks, such as wireless communications systems that support 5G networks, initial access refers to a process by which a UE, such as a smartphone or an internet of things (IoT) device, establishes a connection with a Next-Generation Node B (gNB), e.g., the 5G base station. This process begins with a cell search procedure followed by a synchronization process, where the UE first scans for available signals transmitted by the gNB and then synchronizes with the strongest detected signal using a primary synchronization signal (PSS) and a secondary synchronization signal (SSS). Once synchronization is achieved, a random access procedure occurs, allowing the UE to request access to the network via the random access channel (RACH). This procedure can be either contention-based, where multiple devices compete for access, or contention-free, where access is pre-allocated for specific users, such as emergency services.

Following the random access procedure, a radio resource control (RRC) connection establishment phase begins. The UE sends an RRC connection request to the gNB, which responds with an RRC connection setup message. The UE then confirms the setup by sending an RRC connection complete message. Once the connection is established, the gNB proceeds with an authentication and security setup, where it authenticates the UE using protocols such as 5G authentication and key agreement (5G-AKA) or EAP-AKA, ensuring secure communication by establishing encryption keys.

Next, the UE capability exchange and registration phase occurs, during which the UE shares its capabilities, such as supported frequency bands and network slicing preferences. It then registers with the 5G Core Network (5GC) through Non-Access Stratum (NAS) signaling. Finally, the session establishment and resource allocation phase ensures that the network assigns the necessary resources for data transmission, creating a Protocol Data Unit (PDU) session that enables internet or service access.

Initial access is an important process in 5G networks as it ensures efficient and secure connectivity between the UE and the network. It supports fast and reliable device registration, which is essential for applications such as autonomous vehicles, industrial IoT, and smart cities. Additionally, it optimizes power consumption, reduces latency, and improves overall network efficiency.

In 5G networks, a primary cell (PCell) is the main serving cell that a UE connects to for initial access, control signaling, and data transmission. It is responsible for managing the UE's connection and ensuring seamless communication with the network.

The PCell operates in the primary component carrier in carrier aggregation (CA) scenarios, where multiple frequency bands are used to enhance data rates and network capacity. It provides essential control information, including system synchronization, radio resource management, and mobility control. The PCell is always active, and the UE relies on it for maintaining a stable connection.

When dual connectivity (DC) or CA is used, additional cells called secondary cells (SCells) can be assigned to boost data throughput. While the PCell handles the primary signaling and scheduling, SCells supplement it by providing additional bandwidth for faster data transmission.

In 5G, the PCell transmits common channels/signals needed for the initial access, paging and RACH reception while performing scheduling for the SCells transmitting data channels. In 6G, multi carrier scheduling can enhance the network energy savings by transmitting initial access in a single carrier while the scheduling happens in another carrier.

6G multi-carrier scheduling may refer to the technique of dynamically managing and assigning multiple frequency carriers to a UE in a 6G network to enhance data throughput, reliability, and spectral efficiency. This approach builds upon 5G CA and multi-connectivity but introduces more advanced AI-driven scheduling, ultra-high frequency bands, and seamless integration of multiple radio access technologies (RATs).

Also, 6G may have an increased bandwidth in the upper mid-band spectrum e.g., 200 MHz, which requires efficient wideband operation. 6G wideband may refer to the use of extremely large bandwidths in terahertz (THz) and sub-THz frequencies to achieve unprecedented data rates, ultra-low latency, and high spectral efficiency. Unlike 5G, which primarily operates in sub-6 GHz and millimeter-wave (mm Wave) bands (24 GHz-100 GHz), 6G extends into the 100 GHz-1 THz range, enabling multi-gigabit or even terabit-per-second (Tbps) speeds. This vast spectrum availability will allow for higher data capacity, improved network efficiency, and support for next-generation applications such as immersive holographic communications, AI-driven cloud computing, and real-time extended reality (XR). 6G supports a single unified RAT design for various device types and use cases. For instance, certain device or traffic types may require a high data rate while other devices or traffic types may require lower data rates with deep coverage.

This disclosure presents solutions and procedures for multiple bandwidth utilization in a wideband carrier during initial access. As described in more detail herein, one or more aspects of the present disclosure are directed to partitioning a wideband carrier into a plurality of BWPs that are each mapped to a device type, a traffic type, or a combination thereof, transmitting a first set of information on a first BWP of the plurality of BWPs where the first BWP and the first set of information is common for each of the device types or traffic types, transmitting second sets of information on second BWPs of the plurality of BWPs where each of the second BWPs and the second sets of information are configured for a device type or a traffic type, and performing initial access procedure with one or more devices based on the first set of information and the second sets of information.

The solutions described herein improve various characteristics of the NE and/or the UE such as improved initial access procedures, improved signal reliability, improved resource utilization, improved energy efficiency, and improved latency. In this manner, signaling, battery life, and operational efficiencies in NE and/or UE devices can be enhanced.

Aspects of the present disclosure are described in the context of a wireless communications system. Note that one or more aspects from different solutions may be combined.

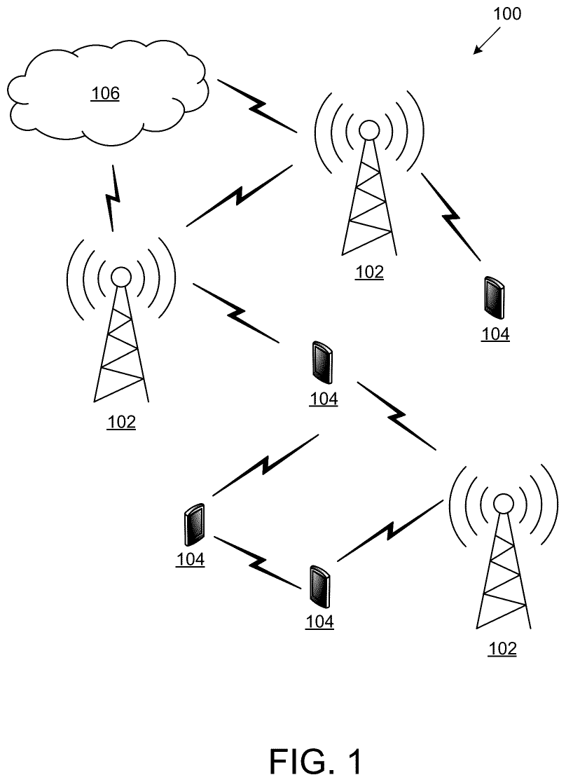

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as a Long-Term Evolution (LTE) network or an LTE-Advanced (LTE-A) network. In some other implementations, the wireless communications system 100 may be a New Radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or a PDN connection, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency domain multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In one example, the system 100 may be used to implement multiple bandwidth utilization in a wideband carrier during initial access. As described in more detail herein, the one or more NEs 102, one or more UEs 104, and CNs 106 in the system 100 may be used for partitioning a wideband carrier into a plurality of BWPs that are each mapped to a device type, a traffic type, or a combination thereof, transmitting a first set of information on a first BWP of the plurality of BWPs where the first BWP and the first set of information is common for each of the device types or traffic types, transmitting second sets of information on second BWPs of the plurality of BWPs where each of the second BWPs and the second sets of information are configured for a device type or a traffic type, and performing initial access procedure with one or more devices based on the first set of information and the second sets of information, which may improve various characteristics of the NEs 102 and/or UEs 104 such as improved initial access procedures, improved signal reliability, improved resource utilization, improved energy efficiency, and improved latency. In this manner, signaling, battery life, and operational efficiencies in the NEs 102 and/or UEs 104 can be enhanced.

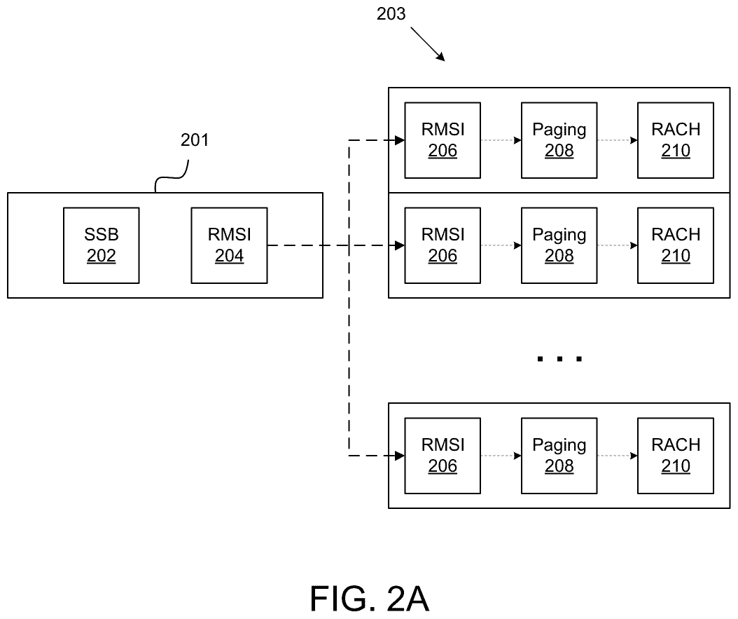

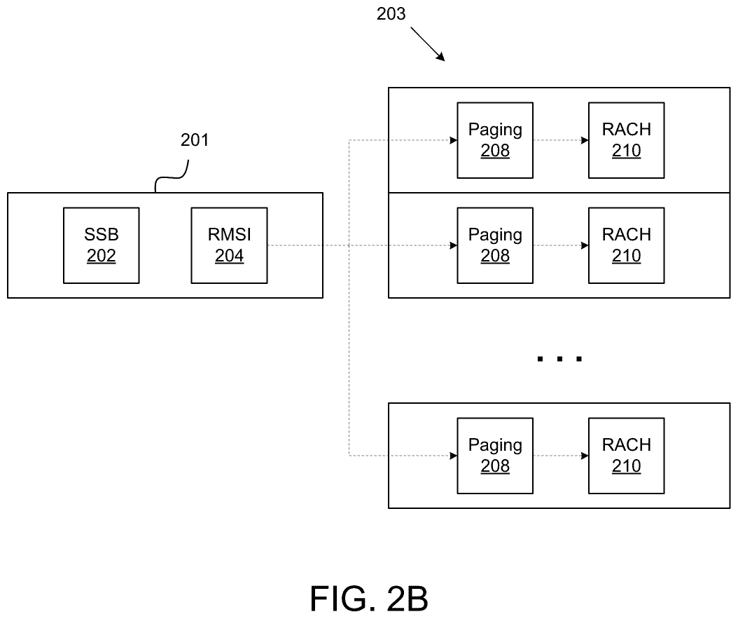

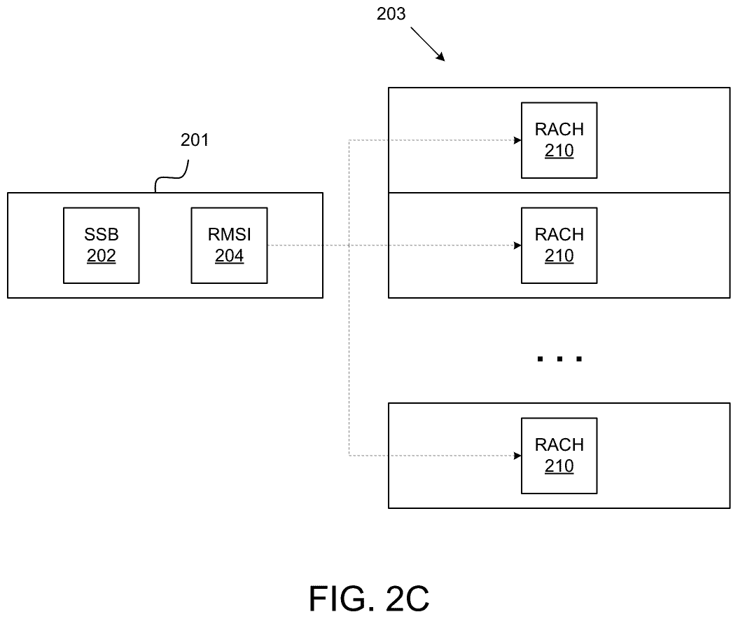

FIG. 2A illustrates an example of wideband operation, in accordance with aspects of the present disclosure. According to a first example, a wideband carrier e.g., a carrier in the 200 MHz range, may be partitioned, divided, or the like into multiple sub-bands or BWPs 201, 203. In such an example, at least one of the sub-bands or BWPs, e.g., a first BWP 201, includes a first set of information that includes a cell-defining synchronization signal block (CD-SSB) 202, in a raster frequency, and an essential portion of a remaining minimum system information (RMSI) 204 e.g., a portion of an RMSI containing cell selection/reselection information, access related information, barring information, frequency band information, downlink and uplink BWP related information, common control resource set (CORESET) information, common search space information for receiving RMSI, or a portion of RMSI, from other BWPs, or a combination thereof. The first BWP 201 may include information that is common for various device types or traffic types.

As used herein, a CD-SSB 202 may refer to the PSS structure that a UE uses to identify and connect to a 5G cell. The SSB serves as the fundamental signal broadcast by the gNB, allowing UEs to detect, synchronize, and access the network. The CD-SSB 202 plays a role in defining a cell because it provides essential system information that enables initial access and mobility functions. It contains three key components: PSS, which helps the UE determine the frame timing and establish synchronization; SSS, which assists in refining synchronization and identifying the physical cell ID (PCI); and physical broadcast channel (PBCH), which carries minimum system information (MSI), including key parameters needed for further communication, such as system bandwidth, subcarrier spacing, and frequency information.

Since the CD-SSB 202 is the first signal that a UE detects when searching for a network, it may act as the identity of the cell. The strongest detected CD-SSB 202 defines which cell the UE will attempt to access and register with. This makes the CD-SSB 202 a fundamental element in cell selection, reselection, and handover procedures in 5G networks.

The CD-SSB 202 also plays a role in beamforming, a key feature of 5G. Unlike LTE, where a single broadcast beam covers the entire cell, 5G uses multiple directional beams. The CD-SSB 202 defines beam positions, helping UEs select the best beam (e.g., beams satisfying a threshold) for communication. Additionally, since SSB reference signal received power (SS-RSRP) is used to measure signal strength, the CD-SSB 202 is used for making mobility and handover decisions.

In different 5G frequency ranges, the role of SSBs varies. In FR1 (Sub-6 GHz) bands, a single SSB can often define a cell due to its wider coverage. However, in FR2 (mmWave) bands, where signals have a shorter range, multiple SSBs are needed to ensure coverage, effectively defining the cell using multiple directional beams.

The CD-SSB 202 is used for ensuring fast and reliable network acquisition, optimizing beam selection and mobility management, and enabling efficient resource allocation in dense 5G environments. As 5G networks continue to evolve, SSB burst structures, indexing, and beam management strategies will play a key role in enhancing network performance and user experience.

In addition, as used herein, RMSI may refer to the essential broadcast information that a UE needs after initial synchronization to access the network and complete the connection setup. RMSI is a subset of System Information (SI) and is broadcast by the gNB to help UEs understand the network configuration. When a UE first connects to a 5G cell, it initially acquires the SSB, which contains basic synchronization and system information. However, additional network parameters are required for proper communication. These parameters are included in the system information block 1 (SIB1), which constitutes RMSI in 5G. The RMSI is periodically broadcast to ensure that UEs receive critical system information without needing to request it explicitly.

As it relates to the subject matter herein, a second set of information may include the non-essential part of the of the RMSI e.g., the second portion of the RMSI 206, and may be transmitted in other sub-bands/BWPs (e.g., second BWPs 203). The second set of information that is sent in the second BWPs 203 may further contain one or more parameters such as a common reference signal (RS) configuration, paging cycle information, paging resource or occasion information, RACH resources, periodicity of common signals/channels transmitted in the BWP, or a combination thereof. Each of the second BWPs 203 may contain information that is specifically for a device type or traffic type. Based on the first and second sets of information, the BS and/or UEs may perform an initial access procedure.

In one example, the base station may configure the first RMSI 204 with information associated with each of the second BWPs 203, including the second RMSI 206, paging information 208 (e.g., paging resources, paging occasions, paging messages, or the like), and/or RACH 210 for one or more device types or traffic types, which distributes the information for different devices across the wideband carrier. In one implementation, the first RMSI 204 may contain identifying information about the second BWPs 203, including a BWP identifier, CORESET information, search space information for monitoring the second RMSI 206 and paging information 208, RACH 210 resources within each BWP 203, or a combination thereof. In such an example, a UE receives the first portion of the RMSI 204 in the first BWP 201 and receives a plurality of common CORESET information for the second BWPs 203 for receiving the second part of the RMSI 206 and to monitor for the paging information 208 in each of the second BWPs 203.

In one example, the base station configures an early paging indicator or low power wake up signal (LPWUS) indicator in the first BWP and paging monitoring occurs in the second BWP. In another implementation, subgrouping for the early paging indicator or LPWUS indicator may be done according to the device type e.g., enhanced mobile broadband (eMBB), IoT, or the like, and assumes different paging cycles due to the different paging arrival and power saving targets for the devices, e.g., for eMBB and IoT devices.

In one example, a two-level hierarchical subgrouping may be utilized. In such an example, the UEs are first subgrouped according to their device type, BWPs in which the paging message is received, or combination thereof. Secondly, an offset is separately configured where the early paging indicator or LPWUS is located in the first BWP while the paging monitoring may be performed in the second BWP. The offset may consider a returning time for UEs to reselect a second BWP or re-synchronize to the second BWP. In one example, different device types may have different returning time periods.

FIG. 2B illustrates an example of wideband operation, in accordance with aspects of the present disclosure. As shown in FIG. 2B, UEs may receive CD-SSBs 202 in the first BWP 201 and may receive all or a portion of the RMSI 204 from the first BWP 201. In one example, the RMSI 204 may contain a configuration, related to the CORESET information, to monitor for the paging information 208 in the second BWP 203 that is mapped to the device type, traffic type, or a combination thereof. In one example, the UE may reselect to the second BWP 203 based on the device type, traffic type, or the like, and, before receiving part of the RMSI 204 or paging information 208, may receive a tracking reference signal (TRS) for finer synchronization within the BWP.

In one example, the RMSI 204 may contain a time-frequency resource configuration, density information associated with a reference signal, e.g., time TRS, or the like. In another implementation, a non-cell defining SSB (e.g., an SSB that is not transmitted a raster frequency) may be transmitted with longer periodicity in the second BWP compared to the cell defining SSBs transmitted in the first BWP. The TRS configuration, which may include density information, periodicity information, or resource mapping information (e.g., information for a time slot, frequency, or the like), may be transmitted in the RMSI. An on-demand SSB configuration may also be transmitted in the RMSI and dynamically activated using dynamic signaling, e.g., DCI, MAC CE, or the like.

FIG. 2C illustrates an example of wideband operation, in accordance with aspects of the present disclosure. In one example, as shown in FIG. 2C, the base station may configure CORESET information within a RMSI 204 to monitor for paging occasions for one or more device types, traffic types, or features in one or more BWPs 203, which distributes devices across the wideband carrier. In one example, UEs receive a plurality of common CORESET information in each of the second BWPs 203 to monitor for the paging message in each of the second BWPs 203 after receiving RMSI 204 from the first BWP 201.

In one example, in a paging burst that includes a plurality of paging occasions that are time-division multiplexed (TDM), a plurality of paging occasions can also be frequency-division multiplexed (FDM) in a paging monitoring occasion in each BWP to accommodate more paging occasions in a slot. In one example, IoT clients may be limited in the number of paging records that can be transmitted in a paging occasion due to bandwidth restrictions, and thus each paging occasion within a FDM-ed paging occasion can be provided to each IoT client. In such an example, IoT clients may know its own FDM-ed paging occasion that incorporates the International Mobile Subscriber Identity (IMSI) or Temporary Mobile Subscriber Identity (TMSI), e.g., a unique identifier assigned to a device that is used in authentication and network access, in the paging formula.

In one example, the base station may configure UEs to monitor an early paging indicator or an LPWUS indicator in one BWP 201 and then the paging monitoring occurs in the second BWP 203, depending on the device type or traffic type. In one example, UEs may be subgrouped according to BWPs 203 in which the paging message is received.

In one example, the UE may need to perform finer synchronization after reselecting to a second BWP 203 from the first BWP 201. In such an example, the TRS configuration may be signaled in the RMSI 204. The RMSI 204 may contain configuration information related to TRS or non-cell defining SSBs in the second BWP 203.

In one example, the base station may configure RACH resources 210 to be transmitted in one or more BWPs 203 for one or more device types, traffic types, features, or the like, and the RMSI 204 may contain separate RACH resource configurations such as configurations for indexes, masks, formats, preambles, time/frequency occasions, and/or the like.

In one implementation, the UE may reselect to a second BWP 203 to perform RACH 210 after receiving the RMSI 204 and paging in the first BWP 201. In such an example, the UE may perform finer synchronization with a downlink signal in the second BWP 203 prior to the RACH 210 transmission. In one example, the UE may reselect to the second BWP 203 and acquire the remaining part of the RMSI 204 containing the RACH resource 210 after receiving the first RMSI 204 and the paging message in the first BWP 201.

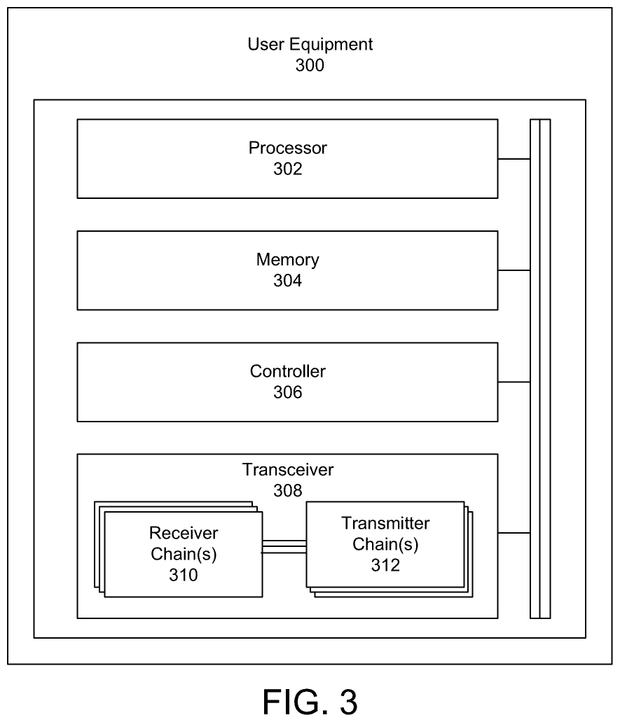

FIG. 3 illustrates an example of a UE 300 in accordance with aspects of the present disclosure. The UE 300 may include a processor 302, a memory 304, a controller 306, and a transceiver 308. The processor 302, the memory 304, the controller 306, or the transceiver 308, or various combinations thereof or various components thereof may be examples of means for performing various aspects of the present disclosure as described herein. These components may be coupled (e.g., operatively, communicatively, functionally, electronically, electrically) via one or more interfaces.

The processor 302, the memory 304, the controller 306, or the transceiver 308, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 302 may include an intelligent hardware device (e.g., a general-purpose processor, a DSP, a central processing unit (CPU), an ASIC, a field programmable gate array (FPGA), or any combination thereof). In some implementations, the processor 302 may be configured to operate the memory 304. In some other implementations, the memory 304 may be integrated into the processor 302. The processor 302 may be configured to execute computer-readable instructions stored in the memory 304 to cause the UE 300 to perform various functions of the present disclosure.

The memory 304 may include volatile or non-volatile memory. The memory 304 may store computer-readable, computer-executable code including instructions that, when executed by the processor 302, cause the UE 300 to perform various functions described herein. The code may be stored in a non-transitory computer-readable medium such the memory 304 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 302 and the memory 304 coupled with the processor 302 may be configured to cause the UE 300 to perform one or more of the UE functions described herein (e.g., executing, by the processor 302, instructions stored in the memory 304). Accordingly, the processor 302 may support wireless communication at the UE 300 in accordance with examples as disclosed herein.

In one example, the UE 300 is configured to receive a first set of information on a first BWP of a plurality of BWPs, wherein the first BWP and the first set of information is common for different device types or traffic types; receive a second set of information on a second BWP of the plurality of BWPs, wherein the first set of information includes an indication of the second BWP based on the device type or traffic type associated with the UE; and perform initial access procedure based on the first set of information and the second set of information.

In one example, the first set of information includes a CD-SSB and at least a portion of RMSI. In one example, the at least a portion of RMSI includes information for identifying the second BWP of the plurality of BWPs for the device type or traffic type associated with the UE.

In one example, the at least a portion of the RMSI includes a BWP identifier, a CORESET, search space information associated with a BWP that includes a second portion of the RMSI, paging occasion information, random access channel (RACH) resources within each BWP, or a combination thereof.

In one example, the at least a portion of the RMSI includes essential RMSI information including cell selection/reselection information, access information, barring information, frequency band information, downlink and uplink BWP information, common CORESET information, common search space information for RMSI of other BWPs, or a combination thereof.

In one example, the second set of information includes at least a portion of RMSI, paging occasion information, RACH, or a combination thereof. In one example, the at least a portion of RMSI includes nonessential RMSI including common reference signal configuration, CORESET information, paging cycle information, paging resource information, RACH information, periodicity information for common signals or channels transmitted in the BWPs, or a combination thereof.

In one example, the first set of information that is transmitted on the first BWP includes a LPWUS indicator, paging occasion information is transmitted on the second BWP, and the first set of information further includes a timing offset associated with the LPWUS that allows the UE 300 to synchronize to the second BWP of the plurality of BWPs.

The controller 306 may manage input and output signals for the UE 300. The controller 306 may also manage peripherals not integrated into the UE 300. In some implementations, the controller 306 may utilize an operating system (OS) such as iOS®, ANDROID®, WINDOWS®, or other operating systems. In some implementations, the controller 306 may be implemented as part of the processor 302.

In some implementations, the UE 300 may include at least one transceiver 308. In some other implementations, the UE 300 may have more than one transceiver 308. The transceiver 308 may represent a wireless transceiver. The transceiver 308 may include one or more receiver chains 310, one or more transmitter chains 312, or a combination thereof.

A receiver chain 310 may be configured to receive signals (e.g., control information, data, packets) over a wireless medium. For example, the receiver chain 310 may include one or more antennas for receiving the signal over the air or wireless medium. The receiver chain 310 may include at least one amplifier (e.g., a low-noise amplifier (LNA)) configured to amplify the received signal. The receiver chain 310 may include at least one demodulator configured to demodulate the received signal and obtain the transmitted data by reversing the modulation technique applied during transmission of the signal. The receiver chain 310 may include at least one decoder for decoding/processing the demodulated signal to receive the transmitted data.

A transmitter chain 312 may be configured to generate and transmit signals (e.g., control information, data, packets). The transmitter chain 312 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 312 may also include at least one power amplifier configured to amplify the modulated signal to an appropriate power level suitable for transmission over the wireless medium. The transmitter chain 312 may also include one or more antennas for transmitting the amplified signal into the air or wireless medium.

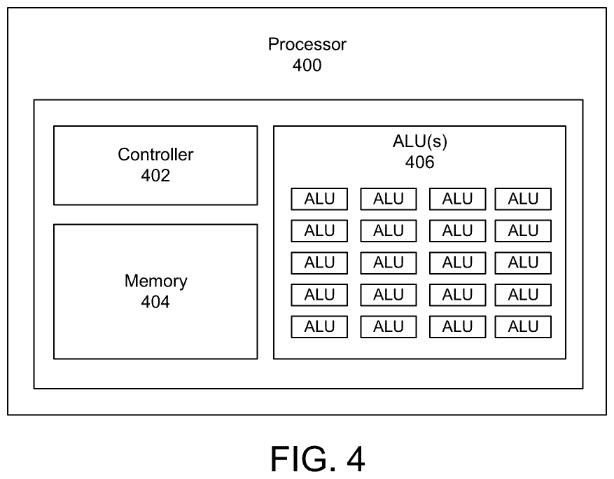

FIG. 4 illustrates an example of a processor 400 in accordance with aspects of the present disclosure. The processor 400 may be an example of a processor configured to perform various operations in accordance with examples as described herein. The processor 400 may include a controller 402 configured to perform various operations in accordance with examples as described herein. The processor 400 may optionally include at least one memory 404, which may be, for example, an L1/L2/L3 cache. Additionally, or alternatively, the processor 400 may optionally include one or more arithmetic-logic units (ALUs) 406. One or more of these components may be in electronic communication or otherwise coupled (e.g., operatively, communicatively, functionally, electronically, electrically) via one or more interfaces (e.g., buses).

The processor 400 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 400) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 402 may be configured to manage and coordinate various operations (e.g., signaling, receiving, obtaining, retrieving, transmitting, outputting, forwarding, storing, determining, identifying, accessing, writing, reading) of the processor 400 to cause the processor 400 to support various operations in accordance with examples as described herein. For example, the controller 402 may operate as a control unit of the processor 400, generating control signals that manage the operation of various components of the processor 400. These control signals include enabling or disabling functional units, selecting data paths, initiating memory access, and coordinating timing of operations.

The controller 402 may be configured to fetch (e.g., obtain, retrieve, receive) instructions from the memory 404 and determine subsequent instruction(s) to be executed to cause the processor 400 to support various operations in accordance with examples as described herein. The controller 402 may be configured to track memory address of instructions associated with the memory 404. The controller 402 may be configured to decode instructions to determine the operation to be performed and the operands involved. For example, the controller 402 may be configured to interpret the instruction and determine control signals to be output to other components of the processor 400 to cause the processor 400 to support various operations in accordance with examples as described herein. Additionally, or alternatively, the controller 402 may be configured to manage flow of data within the processor 400. The controller 402 may be configured to control transfer of data between registers, arithmetic logic units (ALUs), and other functional units of the processor 400.

The memory 404 may include one or more caches (e.g., memory local to or included in the processor 400 or other memory, such RAM, ROM, DRAM, SDRAM, SRAM, MRAM, flash memory, etc. In some implementations, the memory 404 may reside within or on a processor chipset (e.g., local to the processor 400). In some other implementations, the memory 404 may reside external to the processor chipset (e.g., remote to the processor 400).

The memory 404 may store computer-readable, computer-executable code including instructions that, when executed by the processor 400, cause the processor 400 to perform various functions described herein. The code may be stored in a non-transitory computer-readable medium such as system memory or another type of memory. The controller 402 and/or the processor 400 may be configured to execute computer-readable instructions stored in the memory 404 to cause the processor 400 to perform various functions. For example, the processor 400 and/or the controller 402 may be coupled with or to the memory 404, the processor 400, the controller 402, and the memory 404 may be configured to perform various functions described herein. In some examples, the processor 400 may include multiple processors and the memory 404 may include multiple memories. One or more of the multiple processors may be coupled with one or more of the multiple memories, which may, individually or collectively, be configured to perform various functions herein.

The one or more ALUs 406 may be configured to support various operations in accordance with examples as described herein. In some implementations, the one or more ALUs 406 may reside within or on a processor chipset (e.g., the processor 400). In some other implementations, the one or more ALUs 406 may reside external to the processor chipset (e.g., the processor 400). One or more ALUs 406 may perform one or more computations such as addition, subtraction, multiplication, and division on data. For example, one or more ALUs 406 may receive input operands and an operation code, which determines an operation to be executed. One or more ALUs 406 be configured with a variety of logical and arithmetic circuits, including adders, subtractors, shifters, and logic gates, to process and manipulate the data according to the operation. Additionally, or alternatively, the one or more ALUs 406 may support logical operations such as AND, OR, exclusive-OR (XOR), not-OR (NOR), and not-AND (NAND), enabling the one or more ALUs 406 to handle conditional operations, comparisons, and bitwise operations.

In various examples, the processor 400 may support wireless communication of a UE, in accordance with examples as disclosed herein. In other examples, the processor 400 may support wireless communication of a RAN entity, in accordance with examples as disclosed herein.

In one example, the processor 400 is configured to receive a first set of information on a first BWP of a plurality of BWPs, wherein the first BWP and the first set of information is common for different device types or traffic types; receive a second set of information on a second BWP of the plurality of BWPs, wherein the first set of information includes an indication of the second BWP based on the device type or traffic type associated with the UE; and perform initial access procedure based on the first set of information and the second set of information.

In one example, the first set of information includes a CD-SSB and at least a portion of RMSI. In one example, the at least a portion of RMSI includes information for identifying the second BWP of the plurality of BWPs for the device type or traffic type associated with the UE.

In one example, the at least a portion of the RMSI includes a BWP identifier, a CORESET, search space information associated with a BWP that includes a second portion of the RMSI, paging occasion information, random access channel (RACH) resources within each BWP, or a combination thereof.

In one example, the at least a portion of the RMSI includes essential RMSI information including cell selection/reselection information, access information, barring information, frequency band information, downlink and uplink BWP information, common CORESET information, common search space information for RMSI of other BWPs, or a combination thereof.

In one example, the second set of information includes at least a portion of RMSI, paging occasion information, RACH, or a combination thereof. In one example, the at least a portion of RMSI includes nonessential RMSI including common reference signal configuration, CORESET information, paging cycle information, paging resource information, RACH information, periodicity information for common signals or channels transmitted in the BWPs, or a combination thereof.

In one example, the first set of information that is transmitted on the first BWP includes a LPWUS indicator, paging occasion information is transmitted on the second BWP, and the first set of information further includes a timing offset associated with the LPWUS that allows the UE to synchronize to the second BWP of the plurality of BWPs.

In one example, the processor 400 is configured to partition a wideband carrier into a plurality of BWPs, wherein each of the plurality of BWPs is mapped to a device type, a traffic type, or a combination thereof; transmit a first set of information on a first BWP of the plurality of BWPs, wherein the first BWP and the first set of information is common for each of the device types or traffic types; transmit second sets of information on second BWPs of the plurality of BWPs, wherein each of the second BWPs and the second sets of information are configured for a device type or a traffic type; and perform initial access procedure with one or more devices based on the first set of information and the second sets of information.

In one example, the first set of information includes a CD-SSB and at least a portion of RMSI. In one example, the at least a portion of RMSI includes information for identifying the second BWPs of the plurality of BWPs for the device types or traffic types.

In one example, the at least a portion of the RMSI includes a BWP identifier, a CORESET, search space information associated with a BWP that includes a second portion of the RMSI, paging occasion information, RACH resources within each BWP, or a combination thereof. In one example, the at least a portion of the RMSI includes essential RMSI information including cell selection/reselection information, access information, barring information, frequency band information, downlink and uplink BWP information, common CORESET information, common search space information for RMSI of other BWPs, or a combination thereof.

In one example, the second sets of information includes at least a portion of RMSI, paging occasion information, RACH, or a combination thereof. In one example, the at least a portion of RMSI includes nonessential RMSI including common reference signal configuration, CORESET information, paging cycle information, paging resource information, RACH information, periodicity information for common signals or channels transmitted in the BWPs, or a combination thereof.

In one example, the first set of information that is transmitted on the first BWP includes a LPWUS indicator, and wherein paging occasion information is transmitted on the second BWPs. In one example, the at least one processor is configured to cause the BS to partition the plurality of BWPs based on a device type associated with the LPWUS.

In one example, the first set of information further includes a timing offset associated with the LPWUS, the timing offset allowing for device types that utilize the LPWUS to synchronize to a second BWP of the plurality of BWPs.

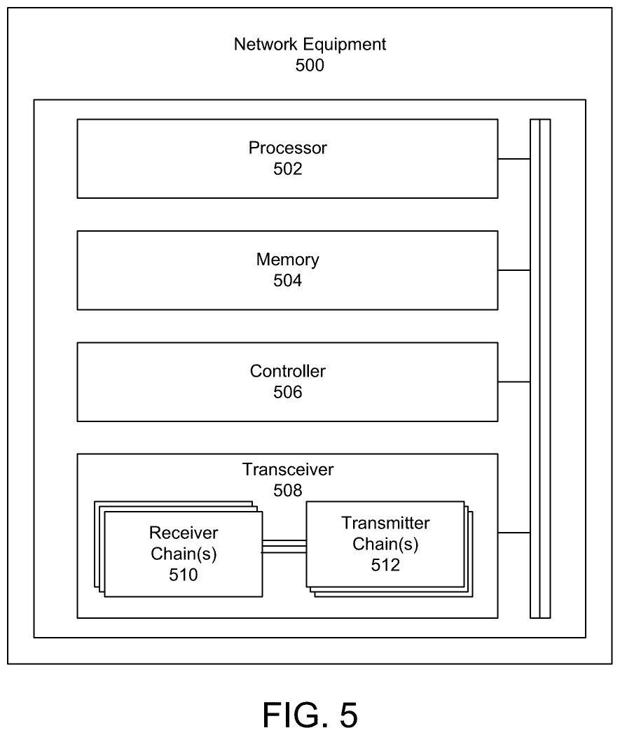

FIG. 5 illustrates an example of a NE 500 in accordance with aspects of the present disclosure. The NE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, an FPGA, or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the NE 500 to perform various functions of the present disclosure.

The memory 504 may include volatile or non-volatile memory. The memory 504 may store computer-readable, computer-executable code including instructions when executed by the processor 502 cause the NE 500 to perform various functions described herein. The code may be stored in a non-transitory computer-readable medium such the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the NE 500 to perform one or more of the RAN functions described herein (e.g., executing, by the processor 502, instructions stored in the memory 504). For example, the processor 502 may support wireless communication at the NE 500 in accordance with examples as disclosed herein.

In one example, the NE 500 is configured to partition a wideband carrier into a plurality of BWPs, wherein each of the plurality of BWPs is mapped to a device type, a traffic type, or a combination thereof; transmit a first set of information on a first BWP of the plurality of BWPs, wherein the first BWP and the first set of information is common for each of the device types or traffic types; transmit second sets of information on second BWPs of the plurality of BWPs, wherein each of the second BWPs and the second sets of information are configured for a device type or a traffic type; and perform initial access procedure with one or more devices based on the first set of information and the second sets of information.

In one example, the first set of information includes a CD-SSB and at least a portion of RMSI. In one example, the at least a portion of RMSI includes information for identifying the second BWPs of the plurality of BWPs for the device types or traffic types.

In one example, the at least a portion of the RMSI includes a BWP identifier, a CORESET, search space information associated with a BWP that includes a second portion of the RMSI, paging occasion information, RACH resources within each BWP, or a combination thereof. In one example, the at least a portion of the RMSI includes essential RMSI information including cell selection/reselection information, access information, barring information, frequency band information, downlink and uplink BWP information, common CORESET information, common search space information for RMSI of other BWPs, or a combination thereof.

In one example, the second sets of information includes at least a portion of RMSI, paging occasion information, RACH, or a combination thereof. In one example, the at least a portion of RMSI includes nonessential RMSI including common reference signal configuration, CORESET information, paging cycle information, paging resource information, RACH information, periodicity information for common signals or channels transmitted in the BWPs, or a combination thereof.

In one example, the first set of information that is transmitted on the first BWP includes a LPWUS indicator, and wherein paging occasion information is transmitted on the second BWPs. In one example, the at least one processor is configured to cause the BS to partition the plurality of BWPs based on a device type associated with the LPWUS.

In one example, the first set of information further includes a timing offset associated with the LPWUS, the timing offset allowing for device types that utilize the LPWUS to synchronize to a second BWP of the plurality of BWPs.

The controller 506 may manage input and output signals for the NE 500. The controller 506 may also manage peripherals not integrated into the NE 500. In some implementations, the controller 506 may utilize an operating system such as iOS®, ANDROID®, WINDOWS®, or other operating systems. In some implementations, the controller 506 may be implemented as part of the processor 502.

In some implementations, the NE 500 may include at least one transceiver 508. In some other implementations, the NE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas for receiving the signal over the air or wireless medium. The receiver chain 510 may include at least one amplifier (e.g., a low-noise amplifier (LNA)) configured to amplify the received signal. The receiver chain 510 may include at least one demodulator configured to demodulate the received signal and obtain the transmitted data by reversing the modulation technique applied during transmission of the signal. The receiver chain 510 may include at least one decoder for decoding/processing the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

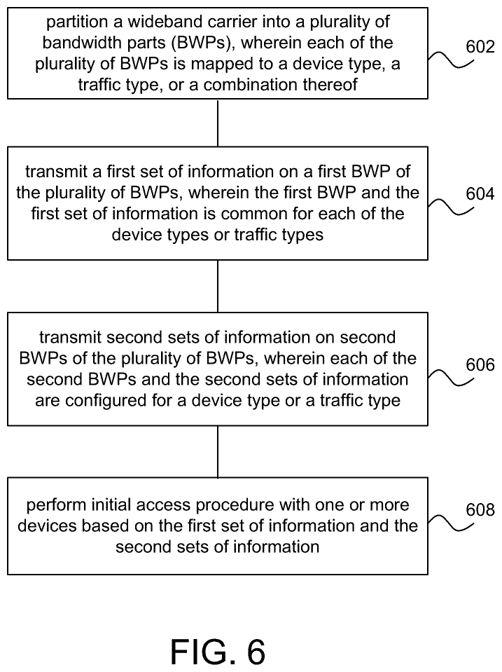

FIG. 6 illustrates a flowchart of a method performed by an NE 500 in accordance with aspects of the present disclosure. The operations of the method may be implemented by an NE 500 as described herein. In some implementations, the NE 500 may execute a set of instructions to control the function elements of the NE 500 to perform the described functions.

At step 602, the method may partition a wideband carrier into a plurality of BWPs, wherein each of the plurality of BWPs is mapped to a device type, a traffic type, or a combination thereof. The operations of step 602 may be performed in accordance with examples as described herein. In some implementations, aspects of the operations of step 602 may be performed by an NE 500, as described with reference to FIG. 5.

At step 604, the method may transmit a first set of information on a first BWP of the plurality of BWPs, wherein the first BWP and the first set of information is common for each of the device types or traffic types. The operations of step 604 may be performed in accordance with examples as described herein. In some implementations, aspects of the operations of step 604 may be performed by an NE 500, as described with reference to FIG. 5.

At step 606, the method may transmit second sets of information on second BWPs of the plurality of BWPs, wherein each of the second BWPs and the second sets of information are configured for a device type or a traffic type. The operations of step 606 may be performed in accordance with examples as described herein. In some implementations, aspects of the operations of step 606 may be performed by an NE 500, as described with reference to FIG. 5.

At step 608, the method may perform initial access procedure with one or more devices based on the first set of information and the second sets of information. The operations of step 608 may be performed in accordance with examples as described herein. In some implementations, aspects of the operations of step 608 may be performed by an NE 500, as described with reference to FIG. 5.

It should be noted that the method described herein describes one possible implementation, and that the operations and the steps may be rearranged or otherwise modified and that other implementations are possible.

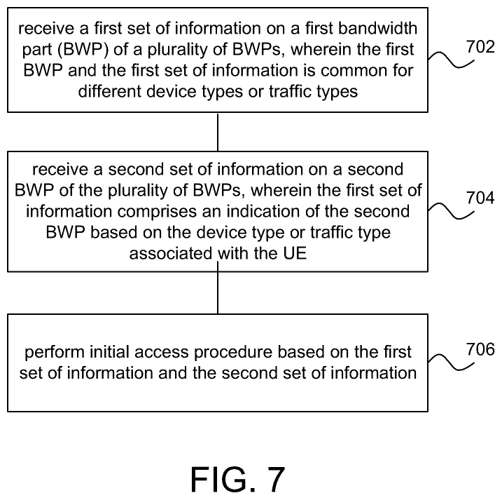

FIG. 7 illustrates a flowchart of a method performed by a UE 300 in accordance with aspects of the present disclosure. The operations of the method may be implemented by a UE 300 as described herein. In some implementations, the UE 300 may execute a set of instructions to control the function elements of the UE 300 to perform the described functions.

At step 702, the method may receive a first set of information on a first BWP of a plurality of BWPs, wherein the first BWP and the first set of information is common for different device types or traffic types. The operations of step 702 may be performed in accordance with examples as described herein. In some implementations, aspects of the operations of step 702 may be performed by a UE 300, as described with reference to FIG. 3.

At step 704, the method may receive a second set of information on a second BWP of the plurality of BWPs, wherein the first set of information includes an indication of the second BWP based on the device type or traffic type associated with the UE. The operations of step 704 may be performed in accordance with examples as described herein. In some implementations, aspects of the operations of step 704 may be performed by a UE 300, as described with reference to FIG. 3.

At step 706, the method may perform initial access procedure based on the first set of information and the second set of information. The operations of step 706 may be performed in accordance with examples as described herein. In some implementations, aspects of the operations of step 706 may be performed by a UE 300, as described with reference to FIG. 3.

It should be noted that the method described herein describes one possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A base station (BS) for wireless communication, comprising:
at least one memory; and
at least one processor coupled with the at least one memory and configured to cause the BS to:
partition a wideband carrier into a plurality of bandwidth parts (BWPs), wherein each of the plurality of BWPs is mapped to a device type, a traffic type, or a combination thereof;
transmit a first set of information on a first BWP of the plurality of BWPs, wherein the first BWP and the first set of information is common for each of the device types or traffic types;
transmit second sets of information on second BWPs of the plurality of BWPs, wherein each of the second BWPs and the second sets of information are configured for a device type or a traffic type; and
perform initial access procedure with one or more devices based on the first set of information and the second sets of information.

2. The BS of claim 1, wherein the first set of information comprises a cell-defining synchronization signal block (CD-SSB) and at least a portion of remaining minimum system information (RMSI).

3. The BS of claim 2, wherein the at least a portion of RMSI comprises information for identifying the second BWPs of the plurality of BWPs for the device types or traffic types.

4. The BS of claim 3, wherein the at least a portion of the RMSI comprises a BWP identifier, a control resource set (CORESET), search space information associated with a BWP that comprises a second portion of the RMSI, paging occasion information, random access channel (RACH) resources within each BWP, or a combination thereof.

5. The BS of claim 2, wherein the at least a portion of the RMSI comprises essential RMSI information including cell selection/reselection information, access information, barring information, frequency band information, downlink and uplink BWP information, common CORESET information, common search space information for RMSI of other BWPs, or a combination thereof.

6. The BS of claim 1, wherein the second sets of information comprise at least a portion of remaining minimum system information (RMSI), paging occasion information, random access channel information (RACH), or a combination thereof.

7. The BS of claim 6, wherein the at least a portion of RMSI comprises nonessential RMSI including common reference signal configuration, control resource set (CORESET) information, paging cycle information, paging resource information, RACH information, periodicity information for common signals or channels transmitted in the BWPs, or a combination thereof.

8. The BS of claim 1, wherein the first set of information that is transmitted on the first BWP comprises a low-power wake up signal (LPWUS) indicator, and wherein paging occasion information is transmitted on the second BWPs.

9. The BS of claim 8, wherein the at least one processor is configured to cause the BS to partition the plurality of BWPs based on a device type associated with the LPWUS.

10. The BS of claim 8, wherein the first set of information further comprises a timing offset associated with the LPWUS, the timing offset allowing for device types that utilize the LPWUS to synchronize to a second BWP of the plurality of BWPs.

11. A method of a base station (BS), comprising:
partitioning a wideband carrier into a plurality of bandwidth parts (BWPs), wherein each of the plurality of BWPs is mapped to a device type, a traffic type, or a combination thereof;
transmitting a first set of information on a first BWP of the plurality of BWPs, wherein the first BWP and the first set of information is common for each of the device types or traffic types;
transmitting second sets of information on second BWPs of the plurality of BWPs, wherein each of the second BWPs and the second sets of information are configured for a device type or a traffic type; and
performing initial access procedure with one or more devices based on the first set of information and the second sets of information.

12. A user equipment (UE) for wireless communication, comprising:
at least one memory; and
at least one processor coupled with the at least one memory and configured to cause the UE to:
receive a first set of information on a first bandwidth part (BWP) of a plurality of BWPs, wherein the first BWP and the first set of information is common for different device types or traffic types;
receive a second set of information on a second BWP of the plurality of BWPs, wherein the first set of information comprises an indication of the second BWP based on the device type or traffic type associated with the UE; and
perform initial access procedure based on the first set of information and the second set of information.

13. The UE of claim 12, wherein the first set of information comprises a cell-defining synchronization signal block (CD-SSB) and at least a portion of remaining minimum system information (RMSI).

14. The UE of claim 13, wherein the at least a portion of RMSI comprises information for identifying the second BWP of the plurality of BWPs for the device type or traffic type associated with the UE.

15. The UE of claim 14, wherein the at least a portion of the RMSI comprises a BWP identifier, a control resource set (CORESET), search space information associated with a BWP that comprises a second portion of the RMSI, paging occasion information, random access channel (RACH) resources within each BWP, or a combination thereof.

16. The UE of claim 13, wherein the at least a portion of the RMSI comprises essential RMSI information including cell selection/reselection information, access information, barring information, frequency band information, downlink and uplink BWP information, common CORESET information, common search space information for RMSI of other BWPs, or a combination thereof.

17. The UE of claim 12, wherein the second set of information comprises at least a portion of remaining minimum system information (RMSI), paging occasion information, random access channel information (RACH), or a combination thereof.

18. The UE of claim 17, wherein the at least a portion of RMSI comprises nonessential RMSI including common reference signal configuration, control resource set (CORESET) information, paging cycle information, paging resource information, RACH information, periodicity information for common signals or channels transmitted in the BWPs, or a combination thereof.

19. The UE of claim 12, wherein:
the first set of information that is transmitted on the first BWP comprises a low-power wake up signal (LPWUS) indicator;
paging occasion information is transmitted on the second BWP; and
the first set of information further comprises a timing offset associated with the LPWUS, the timing offset allowing the UE to synchronize to the second BWP of the plurality of BWPs.

20. A method of a user equipment (UE), comprising:
receiving a first set of information on a first bandwidth part (BWP) of a plurality of BWPs, wherein the first BWP and the first set of information is common for different device types or traffic types;
receiving a second set of information on a second BWP of the plurality of BWPs, wherein the first set of information comprises an indication of the second BWP based on the device type or traffic type associated with the UE; and
performing initial access procedure based on the first set of information and the second set of information.
